(19) United States
(12) Patent Application Publication
(10) Pub. No.: US 2014/0175068 A1
(43) Pub. Date: Jun. 26, 2014

(54) REMOTE LASER WELDING

(71) Applicant: GM GLOBAL TECHNOLOGY OPERATIONS LLC, Detroit, MI (US)

(72) Inventors: Michael G. Poss, Rochester Hills, MI (US); Lance T. Ransom, Essex (CA)

(73) Assignee: GM GLOBAL TECHNOLOGY OPERATIONS LLC, DETROIT, MI (US)

(21) Appl. No.: 13/721,434

(22) Filed: Dec. 20, 2012

(51) Int. Cl. B23K 26/20

(52) U.S. Cl. CPC B23K 26/20
USPC 219/121.64

(57) ABSTRACT

A method of laser welding a first part to a second part including: shining a pointer laser, redirected by a bending mirror, to form a laser beam directed toward the first and second parts to create a laser stripe on the parts; detecting the laser stripe with a camera that is coaxially located and receives an image along an axis defined by the laser beam; processing the image with a camera processor to detect a location of the feature; automatically adjusting a laser welding system to account for the location of the feature; and activating a welding laser, directed through the bending mirror, to weld the first part to the second part.

### BACKGROUND OF INVENTION

The present invention relates generally to laser welding and more particularly to automatically locating parts and seams for laser welding applications.

Remote laser welding with seam tracking to assure the proper weld location are known in the art. Existing remote laser seam tracking sensors are available with external laser line generator light sources. Some laser welding systems may track a joint, but not initially find the joint. These systems typically rely on robot motion to reposition the weld optic from one weld to the next weld, and thus are not scanner based remote laser welding systems.

### SUMMARY OF INVENTION

An embodiment contemplates a method of laser welding a first part to a second part, with a visually detectable feature distinguishing the first part from the second part, the method comprising the steps of: shining a pointer laser, redirected by a bending mirror, to form a laser beam directed toward the first and second parts to create a laser stripe on the parts; detecting the laser stripe with a camera that is coaxially located and receives an image along an axis defined by the laser beam; processing the image with a camera processor to detect a location of the feature; automatically adjusting a laser welding system to account for the location of the feature; and activating a welding laser, directed through the bending mirror, to weld the first part to the second part.

An advantage of an embodiment is that by more accurately locating the laser weld remotely, vehicle mass and cost may be reduced by enabling remote laser edge welding and reducing flange size needed for remote laser lap welding. This welding process allows accommodation of variation in part dimensions and positioning (tolerances), thus enabling the remote laser edge welding process and improving the accuracy of remote laser lap welding positioning. In addition, the remote laser edge welding may reduce the need for special techniques for zinc outgassing, thus reducing investment and operating cost. Moreover, this weld method may be used with existing remote laser optics, thus eliminating the need for a special optic.

### BRIEF DESCRIPTION OF DRAWINGS

FIG. 1 is a schematic diagram of a laser welding system and parts to be welded.

FIG. 2 is a schematic view of the parts to be welded and a laser strip illuminated on the parts.

FIG. 3 is a flow chart of the laser welding process.

### DETAILED DESCRIPTION

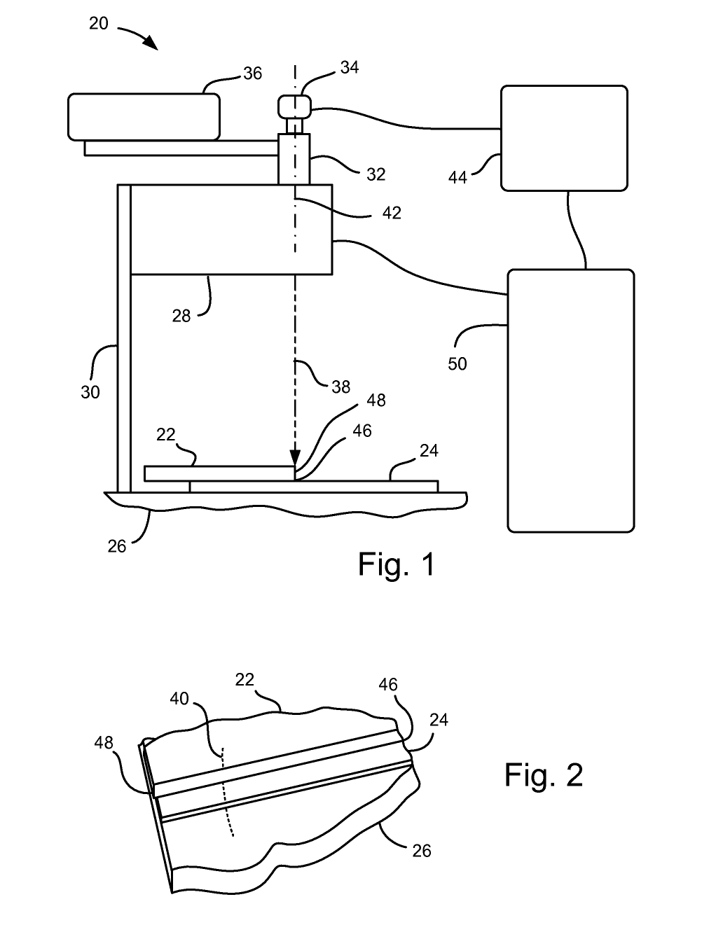

FIGS. 1-2 illustrate a laser welding system 20 used for welding a first part 22 to a second part 24, which are mounted on a support base 26. The laser welding system 20 may include a laser optic 28 and a mechanism 30 for positioning the parts 22, 24 relative to the laser optic 28. The laser optic 28 includes a bending mirror 32, which may be a partially reflective, ninety degree bending mirror. The bending mirror 32 may be conventional and so the details thereof will not be discussed further herein. The bending mirror 32 may be adjustable by the laser optic 28 to redirect the laser as needed.

The laser welding system 20 may also include a camera 34 and a source of laser light 36 (also called a laser source or laser generator). The laser generator 36 may be operated as both a source of a welding laser and source of a pointer laser, with both directed into the bending mirror 32 and redirected out of the laser optic 28 as a laser beam 38 toward the parts 22, 24 to be welded. Alternatively, the laser pointer may be an additional laser light source introduced coaxially into the welding laser beam path.

The camera 34 is mounted on the laser optic 28 coaxial (along axis 42) with the laser beam 38 and can detect the laser stripe 40 (shown in dashed lines in FIG. 2) on the surface of the parts 22, 24 when the pointer laser shines laser light on the parts 22, 24. Thus, the camera 34 is mounted on the bending mirror 32 coaxial to the laser beam path and senses the image through the bending mirror 32.

The camera 34 is located above and takes its image through the bending mirror 32 and so the image is directly coaxial to the laser beam path 38 and thus accurately detects the location of the laser stripe 40 created on the parts 22, 24. The camera 34 is connected to a camera processor 44. The camera processor 44 can take the images received from the camera 34 and analyze the images, which include the laser stripe 40, to determine where the feature 46 is that distinguishes the first part 22 from the second part 24. For example, if the feature 46 is a step in height due to the first part 22 being stacked on top of the second part 24, then the laser stripe 40 will have an offset 48 in it at the location of the stepped edge between the parts 22, 24. The camera processor 44 can then communicate this position information to a laser optic controller 50. The laser optic controller 50 is connected to the laser optic 28 and can then adjust the laser optic 28 based on the position information to assure that the laser beam 38 generated by the welding laser is directed accurately at the weld joint to be formed between the first and second parts 22, 24.

The feature (a feature that can be visually sensed by the camera and camera processor) can be the stepped edge, as just discussed above. This feature can also be, for example, a hole, slot, radius or bend in one or both parts that will allow for accurate detection of the position of the two parts 22, 24. The camera 34 may be a digital camera with image processing as is known to those skilled in the art. The camera processor 44 can be made up of combinations of hardware and software for use in analyzing digital pictures as is known to those skilled in the art.

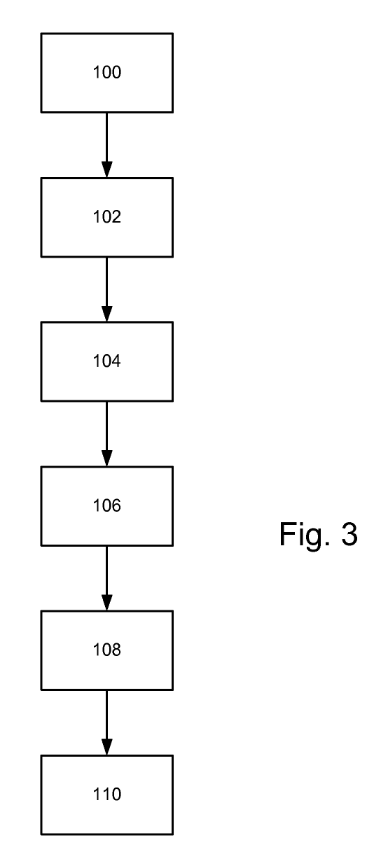

FIG. 3 is a flow chart of a process for aligning the laser with the parts to be welded prior to welding the parts together and will be discussed with reference to FIGS. 1 and 2. The first part 22 and the second part 24 are secured to the support 26 in the relative positions for welding, block 100. The laser source 36 activates the pointer laser, which projects laser light—via the bending mirror 32 of the laser optic 28—onto the parts 22, 24, block 102.

This pointer laser light 38 shines on the parts 22, 24 to create the laser stripe 40. As this pointer laser light is shining on the parts 22, 24, the camera 34 is activated to detect the laser stripe 40, block 104. An image from the camera 34 is transmitted to the camera processor 44, which analyzes the image, having the laser stripe 40 projected onto the parts 22, 24, to detect the feature 46 indicating the position of joint, block 106. This position information is transmitted to the laser optic controller 50, which then adjusts the laser optic 28 to account for the actual position of the parts 22, 24 on the support 26, block 108. For example, laser directing instructions may then be automatically created for this part location information to be used by the laser welding optic controller 50 to offset the programmed path during laser welding. The laser welding system 20 is now ready for welding the parts 22, 24. With the pointer laser and welding laser beams directed at the parts being coaxial with the camera 34, the detection of the feature and accuracy of the location of the welding laser relative to the parts in space is assured.

The welding laser in the laser source 36 is now activated to start the actual process of welding the two parts together, block 110. As the welding is occurring, the location of the welding laser on the parts is moved along the path of the weld (seam) until the weld joint is completed.

While certain embodiments of the present invention have been described in detail, those familiar with the art to which this invention relates will recognize various alternative designs and embodiments for practicing the invention as defined by the following claims.

What is claimed is:

1. A method of laser welding a first part to a second part, with a visually detectable feature distinguishing the first part from the second part, the method comprising the steps of:
(a) shining a pointer laser, redirected by a bending mirror, to form a laser beam directed toward the first and second parts to create a laser stripe on the parts;
(b) detecting the laser stripe with a camera that is coaxially located and receives an image along an axis defined by the laser beam;
(c) processing the image with a camera processor to detect a location of the feature;
(d) automatically adjusting a laser welding system to account for the location of the feature; and
(e) after step (d) activating a welding laser, directed through the bending mirror, to weld the first part to the second part.

2. The method of claim 1 wherein step (d) is further defined by adjusting the position of the bending mirror to adjust the laser path to account for the location of the feature.

3. The method of claim 2 wherein the feature is a stepped edge between the first part and the second part when the first part is resting on the second part.

4. The method of claim 2 wherein the pointer laser and the welding laser are created by a single laser generator source.

5. The method of claim 1 wherein the feature is a stepped edge between the first part and the second part when the first part is resting on the second part.

6. The method of claim 1 wherein step (d) is further defined by the automatic adjustment being made by a laser optic controller that controls a position of the bending mirror.

7. The method of claim 1 wherein the pointer laser and the welding laser are created by a single laser generator source.

8. The method of claim 1 wherein step (d) is further defined by the automatic adjustment being a positioning mechanism adjusting a position of a laser optic containing the bending mirror relative to a support base supporting the first part and the second part.

9. A method of laser welding a first part to a second part, with a visually detectable feature distinguishing the first part from the second part, the method comprising the steps of:
(a) shining a pointer laser, redirected by a bending mirror, to form a laser beam directed toward the first and second parts to create a laser stripe on the parts;
(b) detecting the laser stripe with a camera that is coaxially located and receives an image along an axis defined by the laser beam;
(c) processing the image with a camera processor to detect a location of the feature;
(d) automatically adjusting a laser welding system to account for the location of the feature; and
(e) after step (d) activating a welding laser, directed through the bending mirror, to weld the first part to the second part, wherein the pointer laser and the welding laser are created by a single laser generator source.

10. The method of claim 9 wherein step (d) is further defined by adjusting the position of the bending mirror to adjust the laser path to account for the location of the feature.
